(19) United States
(12) Patent Application Publication
(10) Pub. No.: US 2021/0315773 A1
(43) Pub. Date: Oct. 14, 2021

(54) Vertically Stacked Pill Container

(71) Applicant: Healamin, Inc., Las Vegas, NV (US)

(72) Inventor: Evgeny Siskov, Las Vegas, NV (US)

(73) Assignee: Healamin, Inc., Las Vegas, NV (US)

(21) Appl. No.: 16/846,328

(22) Filed: Apr. 11, 2020

(51) Int. Cl. A61J 1/03; A61J 7/00; A61J 7/02; B65D 83/04

(52) U.S. Cl. CPC A61J 1/03; B65D 83/04; A61J 7/02; A61J 7/0084

(57) ABSTRACT

Disclosed herein are a stacked pill container, and method of dispensing timed doses of one or two pill types, the container comprising: an upper unit stacked atop an inverted lower unit, each unit comprising a circular side wall housing an inner cavity for storing the same or a different pill type. The lower unit is inverted to temporarily adhere to the bottom end of the upper unit, e.g. via metal plates with magnets. Both units comprise a flat dispensing cap, enabling the user to dispense a dose of pills from either end of the container, and store the container upright. The upper and lower unit further comprise outer markings indicating the type of pill, or time of day to take the dose. In an embodiment, the upper unit displays a sun indicating the morning dose; and the lower unit displays a moon indicating the evening dose.

### FIELD OF THE INVENTION

The present invention relates generally to medication pill containers; and in particular, to a pill bottle comprising two separable, stacked units for housing two different timed doses, such as a morning dose, and an evening dose.

### BACKGROUND OF THE INVENTION

Pill containers for storing over-the-counter (OTC) and prescription medication are well known in the prior art. Normally, containers with multiple compartments for different pill types and/or for individual doses comprise flat rectangular boxes with separate sections for storing pills. For example, each compartment is designated for taking a dose of one or more pill types and/doses based on the day of the week. These flat pill boxes do not easily fit within a medicine cabinet because of their large shape. They are also difficult to refill if the different compartments run out of pills at different times.

What is need within the industry is a pill bottle with more than one compartment for storing pills. The bottle should be able to fit within a medicine cabinet, or the like (e.g. a refrigerator door shelf, purse, canyon luggage, etc.). It should also be able to be easily refill the different compartments one-at-a-time as needed, such as by trading out a compartment prepackaged from a pharmacy (e.g. container and pills).

### SUMMARY OF THE INVENTION

Various embodiments of the present invention comprise a stacked pill container, and method of dispensing timed doses of one or two pill types, the container comprising: an upper unit stacked atop a lower unit, each unit comprising a circular side wall housing an inner cavity for storing a plurality of the same or a different pill type. The lower unit is inverted to temporarily adhere to the bottom end of the upper unit, e.g. magnets on the bottom of the upper and lower unit stick together. Both units comprise a flat dispensing cap, enabling the user to dispense a dose of pills from either end of the container, and store the container upright. The upper and lower unit further comprise outer markings indicating the type of pill, or the time of day to take the dose. In an embodiment, the upper unit displays a sun indicating the morning dose; and the lower unit displays a moon indicating the evening dose. In another embodiment, the markings indicate the pill type.

The present invention further comprises a method of dispensing a properly timed dose of one or more pills, comprising: providing the stacked pill container system (units with pills) as disclosed herein; dispensing a dose of the type one pills from the top unit at a time one (e.g. the morning dose), and flipping the container until the lower unit is upright. Later, the user then dispenses a second dose of the pills from the lower unit at a time two (e.g. evening dose). In an embodiment, the AM pills (i.e. type one pill in unit) and PM pills (i.e. type two pill in unit) are the same type of medication. In another embodiment, they are a different medication.

Other aspects, advantages, and salient features of the invention will become apparent to those skilled in the art from the following detailed description, which, details the invention in different embodiments.

### BRIEF DESCRIPTION OF THE DRAWINGS

The embodiments herein will be better understood from the following detailed description with reference to the drawings.

FIG. 1 is a top, front perspective view of the pill container illustrating the AM and the PM unit.

FIG. 2 is a bottom, rear perspective view illustrating a cap on both ends of the container.

FIG. 3 is a left side view of the container illustrating the caps' finger indention to push the flip top open.

FIG. 4 is a right-side view of the container illustrating the caps' fixed end of the flip top.

FIG. 5 is a top, front perspective view of the pill container with the AM unit and the PM unit separated by pulling apart the middle magnet, and the top and bottom caps in an open position.

FIG. 6 is a top, front, fully exploded, perspective view of the pill container in an embodiment, which illustrates the top AM unit and bottom PM unit separated, each unit comprising a cap, a circular side wall enclosing a cavity able to house a plurality of pills, and a bottom metal plate with at least two outer magnets.

FIG. 7 is a top, front perspective view of the pill container in another embodiment with the AM unit and the PM unit separated by unscrewing the bottom ends apart.

### DETAILED DESCRIPTION OF THE INVENTION

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The use of “including”, “comprising” or “having” and variations thereof herein is meant to encompass the items listed thereafter and equivalents thereof, as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another. As used herein, the term “about” refers to plus or minus the stated amount.

The transitional term “comprising”, which is synonymous with “including,” “containing,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention.

As used herein, the term “about” refers to 5 percent plus and/or minus the stated amount.

As used herein, the term “substantially” refers to a geometric shape that one of ordinary skill in the art would readily recognize, wherein the present invention is significantly, if not exactly, similar in shape to.

As used herein, the term “pill” refers to any solid unit dosage form well known art for orally administering a solid composition, such as by way on non-limiting examples: tablets, capsules, pills, etc.

As used herein, the term “system” refers to the container comprising the upper and the lower unit prefilled with the pills, e.g. as purchased from a pharmacy, or over-the-counter (OTC).

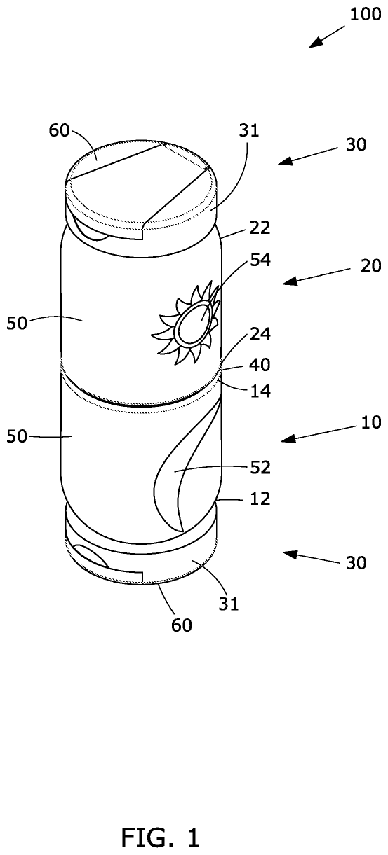

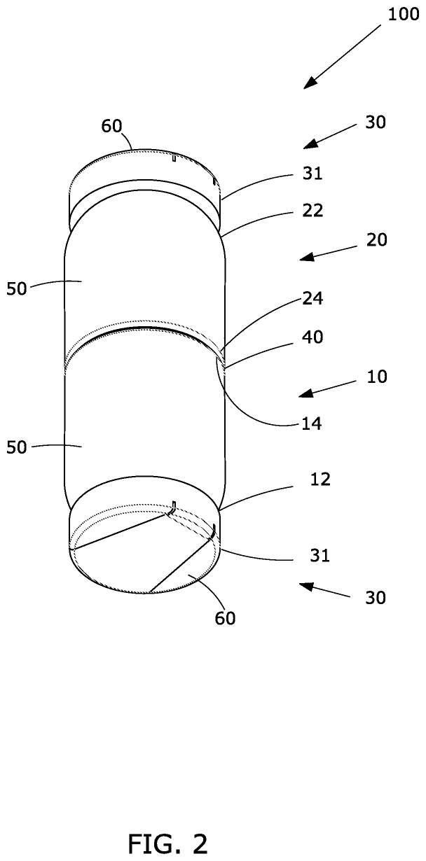

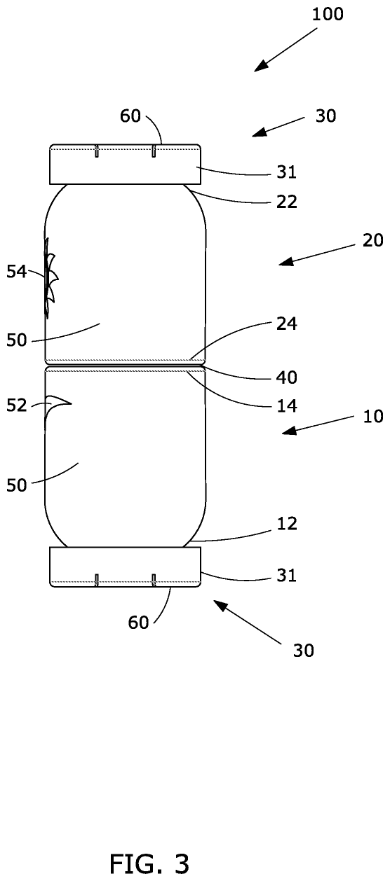

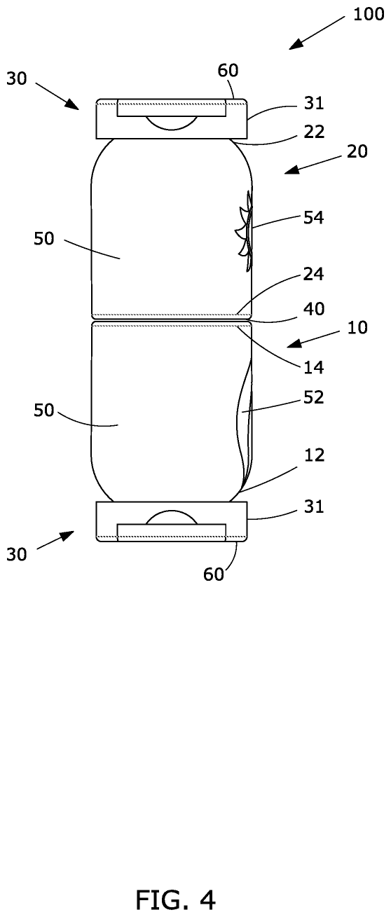

For the sake of convenience and clarity, terms such as “upper”, “lower”, front,” “rear,” “top,” “bottom,” “up,” “down,” “inwardly,” “outwardly,” “lateral,” and “longitudinal” will be used herein to describe the relative placement and orientation of components of the invention, each with respect to the geometry and orientation of the pill container 100 in FIGS. 1-7.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

### Pill Bottle Container

Various embodiments of the present invention comprise a stacked pill container 100 with two units 10, 20 stacked vertical. As illustrated in FIGS. 1-7, both the upper unit 20 and the lower unit 10 comprise: a substantially circular side wall 50 enclosing a cavity 2 that is able to house a plurality of pills, such as one prescription refill; and a dispensing cap 30 with a flat top 60 that enables the pill container 100 to stand upright on a flat surface no matter which unit 20 or 10 is on the bottom. In one exemplary embodiment, container height is about 4.5 to about 6 inches in height, and about 2 inches to about 3 inches in diameter. Other sizes of container 100 are readily known to the skilled artisan, and may be dependent on a variety of factors, such as: size needed to hold one prescription, size needed to be portable (e.g. fit in purse), size needed to fit within shelf of medicine cabinet, etc.

Materials for the side wall 50 and dispensing caps 30 are well known in the art for safely storing pills without contamination, polymer leaching, sufficiently rigid, food-grade, and water-impermeable, such as by way of non-limiting examples: recyclable plastics and plastics fabricated from one or more of: Polystyrene (PS), High Density Polyethylene (HDPE), Low Density Polyethylene (LDPE), Polyethylene Terephthalate (PET), Polyvinyl Chloride (PVC), or Polypropylene (PP). The various components can be formed by injection molding, casting, blow molding, or similar processes that are well known to those skilled in the art.

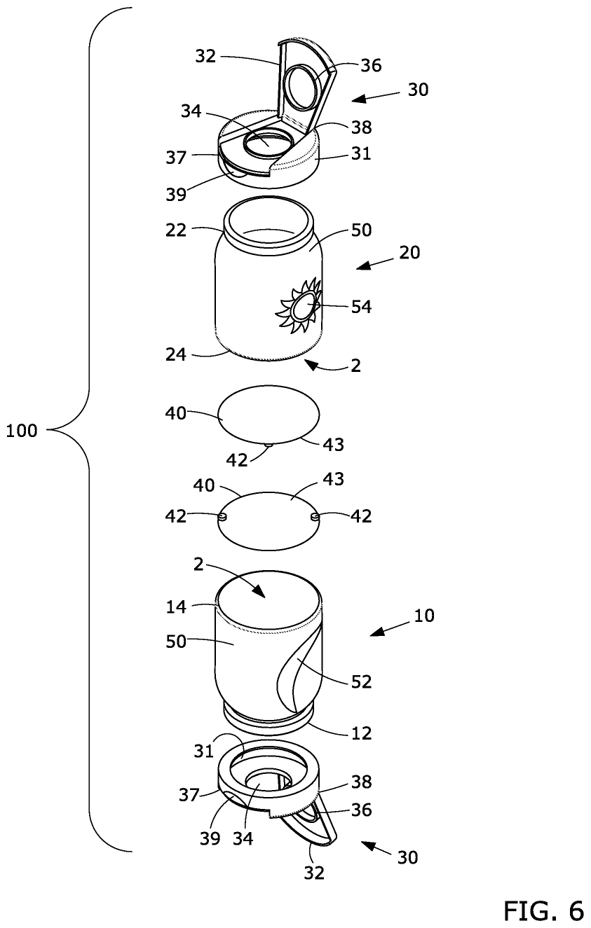

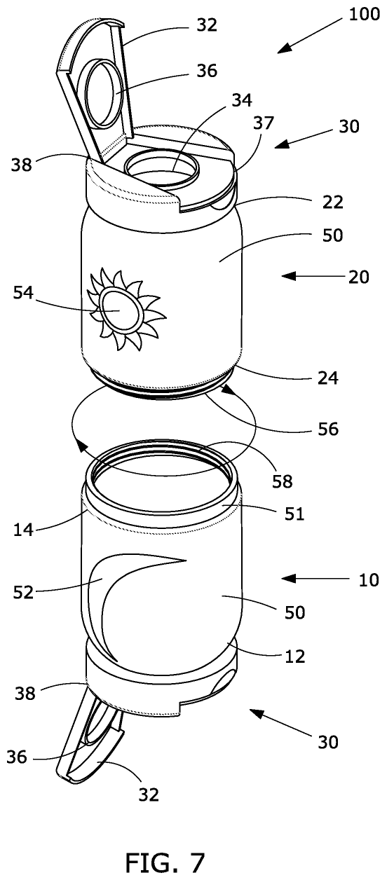

As illustrated in the exploded view of FIGS. 6 and 7, units 10, 20 further comprise: a tapered circular outer open upper end 22 (upper unit 20) and 12 (lower unit 10) for refilling the units by removing their dispensing cap 30. The openings 22 and 12 may comprise internal screw threads (not shown) for screwing a cap 30 on/off; or flat side walls for snapping a dispensing cap 30 on/off.

### Dispensing Cap

In the exemplary embodiment illustrated in FIGS. 1-7, both the upper unit 20 and the lower unit 10 further comprise a snap on dispensing cap 30 with a flat top surface 60 and circular vertical side walls 31.

In another embodiment (not shown), the dispensing caps are a screw on caps well known in the art with a flat top surface 60 and circular vertical side walls 31, and with the inner wall of the caps comprising external screw threads for a screwing cap 30 onto the tapered circular opening 22 of the upper unit 20 and the tapered circular opening 12 of the bottom unit 10.

For the exemplified snap on cap 30, the cap further comprises: a flip top 32 (e.g. substantially rectangular shaped with flared ends at the opening 37) permanently secured on a fixed end 38 to the dispensing cap side wall 31 and able to be pushed into an open position by releasing from an opposing cap end 37. The dispensing cap 30 further comprises an indention 39 below the opposing cap end 37 to enable pushing the flip top 32 with one finger to an open position.

And the underside of the flip top 32 further comprises a circular lip 36 sized to fit the aperture 34 in order to form an airtight seal to protect the pills from contamination.

### Units' Fixation Mechanisms

And both units 10, 20 further comprise a circular closed bottom end 24 (upper unit 20) and 14 (lower unit 10) comprising a flat surface covering the unit cross-sectional area with a mechanism or means to adjoin the upper unit 20 with the lower unit 10 in a manner that they may easily attach and detach when the lower unit is inverted, while also being able to stand upright on a flat surface (e.g. a medicine cabinet shelf).

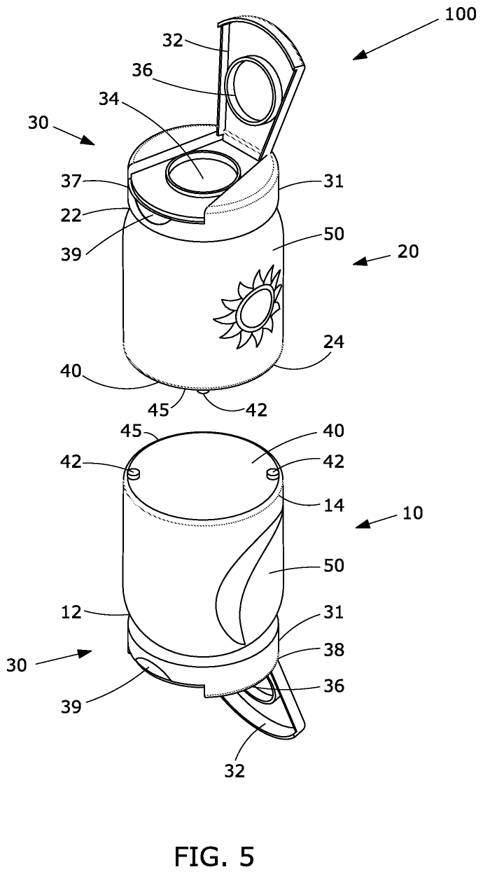

In an embodiment illustrated in FIGS. 5 and 6, the bottom ends 24, 14 each comprise a thin metal plate 40 (about 1-3 millimeters thick) with at least two magnets 42 fixed to the plate outer surface 43. For example, the upper and lower plate 40 each comprise two magnets 42, positioned 180 degrees apart, and the two plates are rotated so that there is one magnet 42 every 45 degrees. The magnets are also in the exemplified embodiment located on the plate outer edge 45, although other magnet 42 locations and the total number of magnets within the container 100 are envisioned within the scope of the present invention. It is noted that even if the plates 40 are rotated 45 degrees to evenly space the four magnets, the upper unit's outer markings 54 are still aligned with the lower unit's markings 52.

Metal plates 40 comprise materials that are attracted to the magnets 42, and will thus strongly adhere to them. For example, metal plates 40 comprise ferromagnetic metals or any combination thereof, such as: iron, nickel, cobalt, gadolinium, dysprosium, and alloys—such as steel that comprises ferromagnetic metals (e.g. iron or nickel). One of ordinary skill in the art would readily know of metals materials to include in metal plates 40 such that they would adhere to magnets 42 and enable the upper unit 20 and the lower unit 10 to stay joined even when container 100 is full of pills and being moved or accidentally dropped.

In another embodiment illustrated in FIG. 7, the means or mechanism of easily attaching and detaching the upper and lower units 10, 20 comprise internal screw threads 56 that threadedly couple to the external screw threads 58 on the circular lip 51 of the opposing unit. For example, in the exemplary illustration of FIG. 7, the top unit 20 comprises the internal screw threads 56 for receiving or screwing the bottom unit 10 onto it via the external threads 58 on the unit 10. It is also within the scope of this invention that the locations of the internal and external screw threads be switched, e.g. the upper unit 20 (e.g. morning) comprises the external circular lip 51 with an internal lining of external screw threads 58 to screw it onto the bottom unit 10 (e.g. evening), which comprises the internal screw threads 56.

### Container Outer Markings

Stacked pill container 100 further comprises aligned markings 52, 54 on the outer surface of the pill container circular side walls 50 of the upper unit 20 and the lower unit 10 indicating the pill type and/or the time of day to take the pill. FIGS. 1-7 exemplify an embodiment in which the markings comprise a sun symbol 54 on the side wall of the upper unit 20, and a moon symbol 52 on the side wall of the lower unit 10, aligned. In this embodiment illustrating the sun and moon, the upper unit 20 and the lower unit 10 comprise the same drug type (so the user can determine by counting if they have missed a morning or evening dose); or they comprise different drug types (e.g. the user takes a different drug in the morning versus in the evening).

In another embodiment (not shown), the markings comprise the name of a first drug on the side wall 54 of the upper unit 20, and the name of a second drug 52 on the side wall 50 of the lower unit 10. This embodiment is particularly useful as a travel pill container to keep the pill types separate, and from cross-contaminating.

### Method of Container Use

One method of dispensing a properly timed dose of one or more pills, comprises: providing the stacked pill container 100 as illustrated in FIG. 1-6 or 7; dispensing a dose of the type one pills from the top unit 20 at a time one (e.g. the morning dose), and flipping the container 100 until the lower unit 10 is upright. Later, the user then dispenses a second dose of the pills from the lower unit 10 at a time two (e.g. evening dose). In an embodiment, the AM pills (i.e. type one pill in unit 20) and PM pills (i.e. type two pill in unit 10) are the same type of medication. In another embodiment, they are a different medication.

When the pills are of the same type in both the upper unit 20 and the lower unit 10, and the dose is the same amount for both times (AM/PM), then the user can count the number of pills remaining in both units to determine if they have missed a dose.

When the pills are of a different type in the upper unit 20 and the lower unit 10, and/or the dose amount is different between time one and time two, then a refill of one unit before the other may be required. In this case, the user can merely detach the units and replace one when a refill is received.

### CONCLUSION

Although a single embodiment of the invention has been illustrated in the accompanying drawings and described in the above detailed description, it will be understood that the invention is not limited to the embodiment developed herein, but is capable of numerous rearrangements, modifications, substitutions of parts and elements without departing from the spirit and scope of the invention. For example, a stacked pill container comprising more than two vertically units is envisioned within the scope of the invention, especially if threaded walls are used as the mechanism to connect the units together. The user merely unscrews the middle units from the container to take a dose of the pills within a middle unit.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A stacked pill container 100, comprising:
an upper unit 20 comprising a pill dispensing end 22, a circular side wall 50 enclosing an inner cavity 2 able to store a plurality of pills, and an enclosed bottom end 24;
a lower unit 10 comprising a pill dispensing end 12, a circular side wall 50 enclosing an inner cavity 2 able to store a plurality of pills, and an enclosed bottom end 14;
a dispensing cap 30 on the dispensing end 22, 12 of both the upper unit and the lower unit; and
a means or mechanism 40 of attaching and detaching the upper unit enclosed bottom end 24 to the lower unit enclosed bottom end 14, to enable the upper unit 10 to be stackable upon the lower unit 20 when the lower unit is inverted.

2. The stacked pill container of claim 1, wherein the means or mechanism of attaching and detaching the upper unit to the lower unit comprises,
a metal plate 40 attached to the upper unit enclosed bottom end 24, with at least two opposing magnets 42 permanently fixed to the outside surface 43 of the metal plate;
a metal plate 40 attached to the lower unit enclosed bottom end 14, with at least two opposing magnets 42 permanently fixed to the outside surface 43 of the metal plate; and
wherein the upper unit 20 and the lower unit 10 are securely able to affix together by the at least four magnets 42 adhering to both the upper unit enclosed bottom end 24 and the lower unit enclosed bottom end 14; and
wherein the upper unit 20 and the lower unit 10 are able to separate by pulling apart.

3. The stacked pill container of claim 2, wherein said container comprises four magnets in total, two per the upper bottom end 24 and the lower bottom end 14, and positioned about 45 degrees apart, and aligned to the metal plates outer edge 43.

4. The stacked pill container of claim 1, wherein the means 40 of attaching and detaching the upper unit to the lower unit comprises internal screw threads 56 extending from the bottom end on either the upper unit or the lower unit, which threadedly couple to an external screw threads 58 on the bottom end of the opposing unit.

5. The stacked pill container of claim 1, wherein the dispensing cap 30 further comprises,
a flip top 32 permanently secured on an end 38 to the dispensing cap, and able to move to an open position by releasing from an opposing cap end 37; and
a circular aperture 34 positioned beneath the flip top 32, said aperture able to release at least one pill from said container when the flip top 32 is in the open position.

6. The stacked pill container of claim 5, wherein the dispensing cap 30 further comprises an indention 39 below the opposing cap end 37 to enable pushing the flip top 32 to an open position.

7. The stacked pill container of claim 1, wherein the dispensing cap 30 further comprises a circular side wall 31 that is able to snap onto and off of the pill dispensing end 12, 14.

8. The stacked pill container of claim 1, further comprising markings 54, 52 on the pill container circular side wall 50 of the upper unit and the lower unit, respectively, indicating the pill type and/or the time of day to take a pill dose.

9. The stacked pill container of claim 8, wherein the markings comprise a sun symbol 54 on the side wall of the upper unit, and a moon symbol 52 on the side wall of the lower unit.

10. The stacked pill container of claim 8, wherein the markings comprise a name of a drug one the side wall of the upper unit, and a name of a drug two on the side wall of the lower unit.

11. A method of dispensing a properly timed dose of one or more pills, comprising:
a. providing a stacked pill container 100 system, comprising:
an upper unit 20 comprising a pill dispensing end 22, a circular side wall 50 enclosing an inner cavity 2 housing a plurality of type one pills, and an enclosed bottom end 24;
an inverted lower unit 10 comprising a pill dispensing end 12, a circular side wall 50 enclosing an inner cavity 2 housing a plurality of type two pills, and an enclosed bottom end 14;
a dispensing cap 30 on the dispensing end of both the upper unit and the lower unit; and
a mechanism 40 of attaching and detaching the upper unit enclosed bottom end 24 to the lower unit enclosed bottom end 14, to enable the upper unit 20 to be stackable upon the lower unit 10 when the lower unit is inverted.
b. dispensing a first dose of the type one pills from the upper unit 20 at a time one, and storing said system upright;
c. dispensing a second dose of the type two pills from the lower unit 10 at a time two; and
d. wherein the type one pills and the type two pills are a same type or are a different type.

12. The method of dispensing of claim 11, wherein the mechanism 40 of attaching and detaching the upper unit to the lower unit comprises,
a metal plate 40 attached to the upper unit enclosed bottom end 24, with at least two opposing magnets 42 permanently fixed to the outside surface 43 of the metal plate;
a metal plate 40 attached to the lower unit enclosed bottom end 14, with at least two opposing magnets 42 permanently fixed to the outside surface 43 of the metal plate; and
wherein the upper unit 20 and the lower unit 10 are securely able to affix together by the at least four magnets 42 adhering to both the upper unit enclosed bottom end 24 and the lower unit enclosed bottom end 14; and
wherein the upper unit 20 and the lower unit 10 are able to separate by pulling apart.

13. The method of dispensing of claim 12, wherein said container comprises four magnets in total, two per metal plate, and positioned about 45 degrees apart, and aligned to the metal plate's outer edge 45.

14. The method of dispensing of claim 11, wherein the mechanism 40 of attaching and detaching the upper unit to the lower unit comprises internal screw threads 56 extending from the bottom end on either the upper unit 20 or the lower unit 10, which threadedly couple to an external screw threads 58 on the bottom end of an opposing unit.

15. The method of dispensing of claim 11, wherein the dispensing cap 30 further comprises,
a flip top 32 permanently secured on an end 38 to the dispensing cap, and able to move to an open position by releasing from an opposing cap end 37; and
a circular aperture 34 positioned beneath the flip top 32, said aperture able to release a pill from said container when the flip top 32 is in the open position.

16. The method of dispensing of claim 15, wherein the dispensing cap 30 further comprises an indention 39 below the opposing cap end 37 to enable pushing the flip top 32 to an open position.

17. The method of dispensing of claim 11, wherein the dispensing cap 30 further comprises a circular side wall 31 that is able to snap onto and off of the pill dispensing end 22, 12.

18. The method of dispensing of claim 11, further comprising markings 54, 52 on the pill container side wall 50 of the upper unit and the lower unit indicating the pill type housed within, and/or the time of day to take a pill dose.

19. The method of dispensing of claim 18, wherein the markings comprise a sun symbol 54 on the side wall of the upper unit, and a moon symbol 52 on the side wall of the lower unit; and a time one is in the morning and a time two is in the evening.

20. The method of dispensing of claim 11, wherein the type one pills and the type two pills are the same, and further comprising monitoring if a dose is missed by counting and comparing a number of type one and type two pills, wherein if a pill count is not equal, then at least one dose was missed at the time one or at the time two.

21. The method of dispensing of claim 11, wherein the type one pills and the type two pills are different, and further comprising separating the upper unit from the lower unit, and replacing either unit with a new unit comprising a refill of the pills.
